(19) United States
(12) Patent Application Publication
(10) Pub. No.: US 2026/0222858 A1
(43) Pub. Date: Jul. 30, 2026

(54) PERFORMANCE MONITORING METHOD AND APPARATUS

(71) Applicant: 1FINITY Inc., Kawasaki-shi (JP)

(72) Inventors: Guotong WANG, Beijing (CN); Xin WANG, Beijing (CN); Gang SUN, Beijing (CN); Qun ZHANG, Beijing (CN); Liqiang JIN, Beijing (CN); Yujia SHAN, Beijing (CN); Tingting GENG, Beijing (CN)

(73) Assignee: 1FINITY Inc., Kawasaki-shi (JP)

(21) Appl. No.: 19/577,922

(22) Filed: Mar. 25, 2026

Related U.S. Application Data
(63) Continuation of application No. PCT/CN2023/122204, filed on Sep. 27, 2023.

(51) Int. Cl. H04W 24/08; H04L 5/00; H04L 41/16; H04W 8/22

(52) U.S. Cl. CPC H04W 24/08; H04L 5/0051; H04L 41/16; H04W 8/22

(57) ABSTRACT

A performance monitoring apparatus, includes: a receiver configured to receive a first configuration transmitted by a network device; a monitor configured to monitor a performance of an AI/ML (Artificial Intelligence/Machine Learning) model with an enabled or activated functionality according to the first configuration, the functionality comprising a feature or a feature group enabled by a configuration indicated by terminal equipment capability; and processor circuitry configured to determine whether or not the functionality fails according to monitoring.

### CROSS-REFERENCE TO RELATED APPLICATION

This application is a continuation application under 35 U.S.C. 111(a) of International Patent Application PCT/CN2023/122204 filed on September 27, 2023, and designated the U.S., the entire contents of which are incorporated herein by reference.

### TECHNICAL FIELD

Embodiments of this disclosure relate to the field of communication technologies.

### BACKGROUND

The AI/ML for air interface is studied in NR Rel-18. The AI/ML may be available in use cases as follows: CSI feedback enhancement, beam management, and positioning enhancement. The CSI feedback enhancement may include CSI prediction and CSI compression; the beam management may include spatial beam prediction and temporal beam prediction; and the positioning enhancement may include direct positioning and AI/ML-assisted positioning.

In some sub-use cases, a bilateral model may be used, that is, AI/ML models are located at a terminal equipment side and a network device side. For example, the CSI compression may be used as a representative use case of a bilateral model. In other sub-use cases, a unilateral model may be used, that is, the AI/ML model is located at the terminal equipment side or at the network device side.

It should be noted that the above introduction to the background is merely provided for clear and complete explanation of the technical solutions of this disclosure and for easy understanding by those skilled in the art. And it should not be understood that these technical solutions are known to those skilled in the art only because they are described in the background of this disclosure.

### SUMMARY

The inventors found that performance should be monitored by a terminal equipment for a AI/ML model located at a terminal equipment side. However, there is currently no clear and accurate solution on how to implement monitoring.

In view of at least one of the above problems, embodiments of this disclosure provide a performance monitoring method and apparatus.

According to one aspect of the embodiments of this disclosure, there is provided a performance monitoring method, including:

receiving, by a terminal equipment, a first configuration transmitted by a network device;

monitoring a performance of an AI/ML model with an enabled or activated functionality according to the first configuration, the functionality including a feature or a feature group enabled by a configuration indicated by terminal equipment capability; and

determining whether or not the functionality fails according to the monitoring.

According to another aspect of the embodiments of this disclosure, there is provided a performance monitoring apparatus, including:

a receiving unit configured to receive a first configuration transmitted by a network device;

a monitoring unit configured to monitor a performance of an AI/ML model with an enabled or activated functionality according to the first configuration, the functionality including a feature or a feature group enabled by a configuration indicated by terminal equipment capability; and

a processing unit configured to determine whether or not the functionality fails according to the monitoring.

According to another aspect of the embodiments of this disclosure, there is provided a performance monitoring method, including:

transmitting, by a network device, a first configuration to a terminal equipment;

wherein the terminal equipment monitors a performance of an AI/ML model with an enabled or activated functionality according to the first configuration, and the functionality includes a feature or a feature group enabled by a configuration indicated by terminal equipment capability; and determines whether or not the functionality fails according to the monitoring.

According to another aspect of the embodiments of this disclosure, there is provided a performance monitoring apparatus, including:

a transmitting unit configured to transmit a first configuration to a terminal equipment;

wherein the terminal equipment monitors a performance of an AI/ML model with an enabled or activated functionality according to the first configuration, and the functionality includes a feature or a feature group enabled by a configuration indicated by terminal equipment capability; and determines whether or not the functionality fails according to the monitoring.

According to another aspect of the embodiments of this disclosure, there is provided a communication system, including:

a network device configured to transmit a first configuration to a terminal equipment;

the terminal equipment configured to monitor a performance of an AI/ML model with an enabled or activated functionality according to the first configuration, wherein the functionality includes a feature or a feature group enabled by a configuration indicated by terminal equipment capability; and determine whether or not the functionality fails according to the monitoring.

One of the advantageous effects of embodiments of this disclosure is that an AI/ML model located at a terminal equipment side is able to be accurately monitored, accuracy and reliability of AI/ML is able to be improved.

With reference to the following description and drawings, the particular embodiments of this disclosure are disclosed in detail, and the manners in which the principle of this disclosure can be used are indicated. It should be understood that the scope of the embodiments of this disclosure is not limited thereto. The embodiments of this disclosure contain many alternations, modifications and equivalents within the clauses of the appended claims.

Features that are described and/or illustrated with respect to one embodiment may be used in a same way or in a similar way in one or more other embodiments and/or in combination with or instead of the features of the other embodiments.

It should be emphasized that the term "comprise/include" when used herein refers to the presence of features, integers, steps or components but does not preclude the presence or addition of one or more other features, integers, steps, or components.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram illustrating a communication system in embodiments of this disclosure;

FIG. 2 is a schematic diagram illustrating a performance monitoring method in embodiments of this disclosure;

FIG. 3 is a schematic diagram illustrating performance monitoring on a functionality in embodiments of this disclosure;

FIG. 4 is an example diagram illustrating performance monitoring on a plurality of functionalities in embodiments of this disclosure;

FIG. 5 is a schematic diagram illustrating a performance monitoring method in embodiments of this disclosure;

FIG. 6 is a schematic diagram illustrating a performance monitoring apparatus in embodiments of this disclosure;

FIG. 7 is a schematic diagram illustrating a performance monitoring apparatus in embodiments of this disclosure;

FIG. 8 is a schematic diagram illustrating a network device in embodiments of this disclosure; and

FIG. 9 is a schematic diagram illustrating a terminal equipment in embodiments of this disclosure.

### DETAILED DESCRIPTION

These and further features of this disclosure will be apparent with reference to the following description and drawings. In the description and drawings, particular embodiments of the disclosure have been disclosed in detail as being indicative of some of the embodiments in which the principles of the disclosure may be employed, but it should be understood that this disclosure is not limited to the embodiments described herein. Rather, this disclosure includes all alternations, modifications and equivalents falling within the scope of the appended claims.

In embodiments of this disclosure, terms "first", "second", etc., are used to differentiate different elements with respect to names, and do not indicate spatial arrangement or temporal orders of these elements, and these elements should not be limited by these terms. Terms "and/or" include any one and all combinations of one or more relevantly listed terms. Terms "contain", "include", "have" refer to presence of stated features, elements, components, or assemblies, but do not exclude presence or addition of one or more other features, elements, components, or assemblies.

In embodiments of this disclosure, singular forms "a/an", "the", etc., include plural forms, and should be understood as "a kind of" or "a type of" in a broad sense, but should not be limited to a meaning of "one"; and the term "the" should be understood as including both a singular form and a plural form, except clearly specified otherwise. Furthermore, the term "according to" should be understood as "at least partially according to", the term "based on" should be understood as "at least partially based on", except clearly specified otherwise.

In embodiments of this disclosure, the term "communication network" or "wireless communication network" may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

Furthermore, communication between devices in a communication system may be performed according to communication protocols at any stage, which may, for example, include but not limited to the communication protocols: 1G (generation), 2G, 2.5G, 2.75G, 3G, 4G, 4.5G, and 5G, New Radio (NR) and 6G in the future, etc., and/or other communication protocols that are currently known or will be developed in the future.

In embodiments of this disclosure, the term "network device", for example, refers to a device in a communication system that accesses terminal equipment to a communication network and provides services for the terminal equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

A base station may include but not limited to a node B (NodeB or NB), an evolved node B (eNodeB or eNB), and a 5G base station (gNB), an IAB host, etc. Furthermore, it may include a remote radio head (RRH), a remote radio unit (RRU), a relay, or a low-power node (such as a femto, and a pico, etc.). The term "base station" may include some or all of its functions, and each base station may provide communication coverage for a specific geographic area. And a term "cell" may refer to a base station and/or its coverage area, depending on a context in which the term is used.

In embodiments of this disclosure, the term "user equipment" (UE) or "terminal equipment or terminal device" (TE) refers to, for example, equipment accessing to a communication network and receiving network services via a network device. The terminal equipment may be fixed or mobile, and may also be referred to as a mobile station (MS), a terminal, a subscriber station (SS), an access terminal (AT), a station, etc.

A terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of an Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term "network side" or "network device side" refers to a side of a network, which may be a base station or one or more network devices including those described above. The term "user side" or "terminal side" or "terminal equipment side" refers to a side of a user or a terminal, which may be a UE, and may include one or more terminal equipment described above. "A device" in this text may refer to a network device, and may also refer to a terminal equipment, except otherwise specified.

Scenarios of embodiments in this disclosure shall be described below by way of examples. However, this disclosure is not limited thereto.

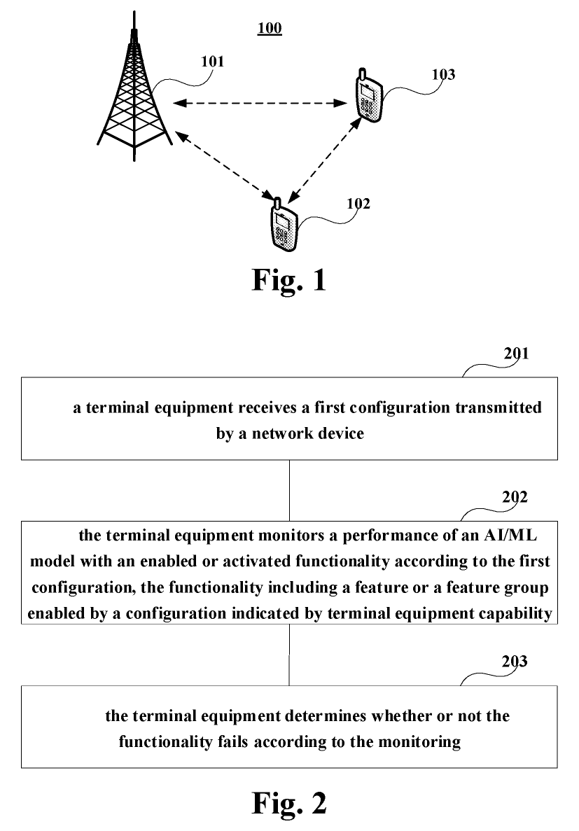

FIG. 1 is a schematic diagram illustrating a communication system in embodiments of this disclosure, which schematically illustrates a situation in which a terminal equipment and a network device are used as an example. As illustrated in the FIG. 1, a communication system 100 may include a network device 101 and terminal equipments 102 and 103. For the sake of simplicity, the FIG. 1 only illustrates two terminal equipments and one network device as an example, however, the embodiments of this disclosure are not limited thereto.

In embodiments of this disclosure, existing services or services that may be implemented in the future may be transmitted between the network device 101 and the terminal equipments 102 and 103. For example, these services may include but are not limited to: an enhanced Mobile Broadband (eMBB), a massive Machine Type Communication (mMTC), and an Ultra-Reliable and Low-Latency Communication (URLLC), etc.

It should be noted that the FIG. 1 illustrates that both the terminal equipments 102 and 103 fall within a coverage of the network device 101, however, this disclosure is not limited thereto. Both the terminal equipments 102 and 103 may not fall within the coverage of the network device 101, or one terminal equipment 102 falls within the coverage of the network device 101 and the other terminal equipment 103 falls out of the coverage of the network device 101.

In embodiments of this disclosure, a higher layer signaling may be, for example, a radio resource control (RRC) signaling; for example, an RRC message, including, for example, an MIB, system information, a dedicated RRC message; or an RRC IE (RRC information element). The higher layer signaling may also be, for example, a MAC (Medium Access Control) signaling; or a MAC CE (MAC control element). However, this disclosure is not limited thereto.

In embodiments of this disclosure, one or more AI/ML models may be configured and run in a network device and/or a terminal equipment. The AI/ML model may be used for signal processing functions of wireless communications, such as CSI prediction, CSI compression, beam prediction, positioning management, etc. This disclosure is not limited thereto.

### Embodiments of a first aspect

Embodiments of this disclosure provide a performance monitoring method. FIG. 2 is a schematic diagram illustrating a performance monitoring method in embodiments of this disclosure. As illustrated in the FIG. 2, the method includes:

201: a terminal equipment receives a first configuration transmitted by a network device;

202: the terminal equipment monitors a performance of an AI/ML model with an enabled or activated functionality according to the first configuration, the functionality including a feature or a feature group enabled by a configuration indicated by terminal equipment capability; and

203: the terminal equipment determines whether or not the functionality fails according to the monitoring.

It should be noted that the FIG. 2 only schematically illustrates embodiments of this disclosure, however, this disclosure is not limited thereto. For example, an order of execution of the operations may be appropriately adjusted, and some other operations may be added, or some operations therein may be removed. And appropriate variants may be made by those skilled in the art according to the above content, without being limited to the disclosure illustrated in the FIG. 2.

In some embodiments, functionality refers to an AI/ML feature/feature group enabled by a configuration, in which the configuration is supported based on conditions indicated by UE capability.

For example, an AL/ML functionality may be one or more functionalities, or may be one or more logical models, or may be one or more sub-functionalities, or may be one or more features, or may be one or more feature groups.

For another example, a functionality may refer to use AI/ML for spatial beam prediction, or use AI/ML for temporal beam prediction, or use AI/ML for CSI prediction, or use AI/ML for direct positioning, or use AI/ML for assisted positioning, etc.

In some embodiments, the AI/ML model is located at a terminal equipment side. The terminal equipment monitors the performance of the AI/ML model and judges (determines, detects) whether the AI/ML performance corresponding to one or some functionalities of the AI/ML model is working properly.

In some embodiments, the first configuration includes at least one of: a performance metric, a parameter for controlling monitoring, or a reference signal configuration. This disclosure is not limited thereto, and the first configuration may include other information/parameter(s)/condition(s)/resource configuration(s) for performance monitoring, etc. In addition, the first configuration may include any one of the above information, or any combination of two or more.

For example, an AI/ML functionality is located at a UE side. After enabling or activating the AI/ML functionality, the UE monitors the AI/ML operation according to a first configuration from a network side. The first configuration may include a performance metric, a parameter for controlling monitoring (e.g., a parameter for failure event triggering, a parameter for activation/deactivation triggering, such as a counter, a timer, a threshold, a condition), a CSI-RS resource configuration, etc. The performance metric may include an AI/ML output performance, a data input/output distribution, a measurement statistic as compared with an input statistic, etc.

In some embodiments, the terminal equipment receives a second configuration transmitted by the network device; and the terminal equipment transmits AI/ML performance information corresponding to the functionality to the network device according to the second configuration.

For example, in a case where the UE is able to detect and determine that the AI/ML functionality is not able to work properly, the UE transmits the AI/ML performance information according to the second configuration from the network side.

In some embodiments, the second configuration includes at least one of: a reporting configuration, an uplink resource for transmitting the AI/ML performance information, or a manner for reporting the AI/ML performance information. The manner includes: a periodic reporting, a semi-persistent reporting, or an aperiodic reporting. The AI/ML performance information includes at least one of: a functionality failure indication, an input data drift, or an output data drift. This disclosure is not limited thereto. In addition, the second configuration or performance information may include any one of the above information, or any combination of two or more.

In some embodiments, the functionality is one or more, and the terminal equipment performs AI/ML performance monitoring on functionalities, respectively.

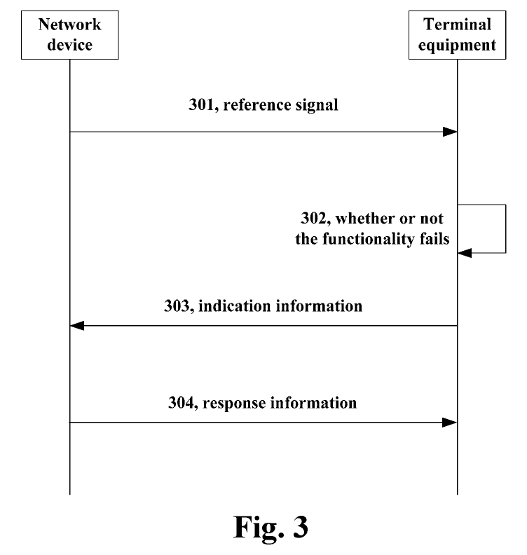

FIG. 3 is a schematic diagram illustrating performance monitoring on a functionality in embodiments of this disclosure. As illustrated in the FIG. 3, the process includes:

301: a terminal equipment receives a reference signal for AI/ML performance monitoring transmitted by a network device; and

302: the terminal equipment determines whether or not the functionality fails according to the reference signal.

For example, a UE monitors an AI/ML performance of a functionality and detects whether or not the performance is degraded. For example, the UE may detect (determine) whether a functionality failure occurs.

303: the terminal equipment transmits indication information to the network device, in a case where the functionality fails; and

304: the terminal equipment receives response information fed back by the network device according to the indication information, the response information including at least one of: functionality activation information, functionality deactivation information, functionality fallback information, functionality switching information or reconfiguration information. This disclosure is not limited thereto. In addition, the response information may include any one of the above information, or any combination of two or more.

It should be noted that the FIG. 3 only schematically illustrates embodiments of this disclosure, however, this disclosure is not limited thereto. For example, an order of execution of the operations may be appropriately adjusted, and some other operations may be added, or some operations therein may be removed And appropriate variants may be made by those skilled in the art according to the above content, without being limited to the disclosure illustrated in the FIG. 3.

In some embodiments, the terminal equipment determines whether or not the functionality fails according to a performance metric; wherein in a case where the performance metric falls below a threshold, one or more failure instances are counted; and in a case where a plurality of consecutive failure instances are detected within a time window, the functionality is determined to fail.

For example, the UE may detect whether a failure occurs based on the performance metric (such as SGCS). If the performance metric falls below a threshold, one or more failure instances are counted. The functionality may be considered (determined, declared) to fail, if the plurality of consecutive failure instances are detected within a time window.

In some embodiments, a reference signal is a periodic signal for AI/ML performance monitoring on one functionality. For example, the reference signal is a periodic CSI-RS.

In some embodiments, a reference signal for AI/ML performance monitoring on one functionality is configured by a radio resource control (RRC), or a reference signal for AI/ML performance monitoring on one functionality is determined by a terminal equipment.

For example, a base station may configure a periodic reference signal for performance monitoring on one functionality. For example, whether a reference signal is used for monitoring, measurement, or prediction may be explicitly identified by an RRC configuration. For another example, whether a reference signal is used for monitoring, measurement, or prediction may not be explicitly configured, and the UE may independently decide whether a reference signal is used for monitoring, measurement, or prediction.

For another example, if a reference signal for performance monitoring is not configured, a reference signal used by the UE for measurement and/or inference may be used for performance monitoring on one or more functionalities.

For another example, the reference signal may be semi-persistent or aperiodic.

In some embodiments, the indication information includes a failure indication of one functionality.

In some embodiments, a failure indication of one functionality is transmitted via at least one of: a dedicated random access channel resource, an uplink control channel (PUCCH) resource, a MAC CE, a two-step random access, or a radio resource control (RRC) message.

For example, the functionality failure indication may be transmitted via a dedicated PRACH. As for one functionality, a dedicated PRACH resource may be configured for the UE.

For another example, the functionality failure indication may be transmitted via a PUCCH (e.g., similar to PUCCH SR) resource. As for one functionality, resources similar to PUCCH SR may be configured for the UE.

For another example, the functionality failure indication may be transmitted via a MAC CE. The MAC CE may be newly defined. A new MAC CE may be introduced for one functionality, or an existing MAC CE may be reused to transmit the functionality failure indication.

For another example, the functionality failure indication may be transmitted via a two-step RACH. For example, the UE may transmit a preamble and a PUSCH to the base station, the functionality failure information is included in the PUSCH, and the UE receives an RA response transmitted by the base station.

For another example, the functionality failure indication may be transmitted via an RRC message. As for one functionality, a separate RRC message may be defined.

In embodiments of this disclosure, different functionalities may use a same manner or different manners to indicate a functionality failure. For example, a dedicated RACH resource may be used to transmit a functionality failure indication for a functionality 1, a MAC CE may be used to transmit a functionality failure indication for a functionality 2, and an RRC message may be used to transmit a functionality failure indication for a functionality 3, etc.

In some embodiments, the response information is for one functionality and is transmitted via at least one of downlink control information (DCI), a MAC CE, or an RRC message.

For example, after receiving the functionality failure indication from the UE, the base station may transmit a response for activation/deactivation/fallback of one functionality or a response for functionality switching/reconfiguration to the UE. The response may be transmitted via DCI/MAC CE/RRC message.

In some embodiments, the reference signal is a periodic signal for AI/ML performance monitoring on a plurality of functionalities.

For example, for model/performance monitoring, one or more steps in the monitoring process illustrated in the FIG. 3 may be used for a plurality of functionalities. For example, the reference signal for performance monitoring and/or functionality failure indication may be used for AI/ML for spatial beam prediction and AI/ML for temporal beam prediction.

In some embodiments, the reference signal for AI/ML performance monitoring on the plurality of functionalities is configured by radio resource control (RRC), or the reference signal for AI/ML performance monitoring on the plurality of functionalities is determined by the terminal equipment.

For example, the base station may configure a periodic reference signal for performance monitoring on the plurality of functionalities. For example, whether the reference signal is used for monitoring, measurement, or prediction may be explicitly identified via an RRC configuration. For another example, whether the reference signal is used for monitoring, measurement, or prediction may not be explicitly configured, and the UE may independently decide whether a reference signal is used for monitoring, measurement, or prediction.

For another example, a reference signal used by the UE for measurement and/or inference may be used for performance monitoring on one or more functionalities, if the reference signal for performance monitoring is not configured.

For another example, the reference signal may be semi-persistent or aperiodic.

In some embodiments, the indication information includes a failure indication of one or more functionalities.

In some embodiments, the failure indication of one or more functionalities is transmitted via at least one of: an uplink control channel resource, a MAC CE, a two-step random access, or a radio resource control (RRC) message.

For example, a functionality failure indication may be transmitted via a resource similar to a PUCCH SR. One resource similar to a PUCCH SR may be configured for a plurality of functionalities. For example, a new MAC CE, which at least contains information about which functionalities fail, may be introduced.

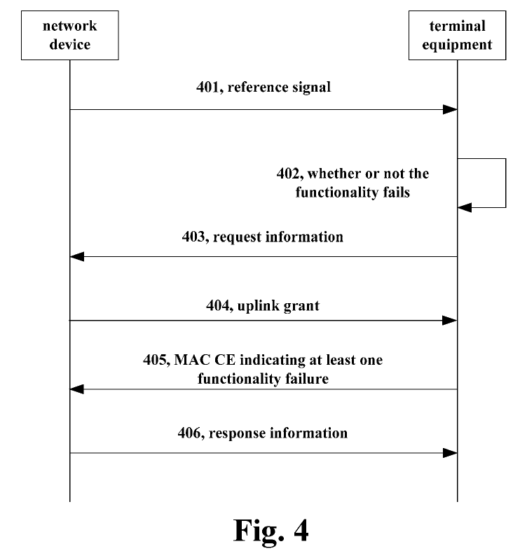

FIG. 4 is an example diagram illustrating performance monitoring on a plurality of functionalities in embodiments of this disclosure. As illustrated in the FIG. 4, the process includes:

401: a terminal equipment receives a reference signal for AI/ML performance monitoring transmitted by a network device;

402: the terminal equipment determines whether or not the functionality fails according to the reference signal;

For example, the UE monitors AI/ML performances of multiple functionalities separately and detects whether the performances are degraded. For example, the UE is able to detect whether a functionality failure occurs.

403: the terminal equipment transmits request information to the network device, in a case where at least one functionality fails;

For example, if at least one functionality fails, the UE transmits a resource similar to a PUCCH SR.

404: the terminal equipment receives an uplink grant transmitted by the network device;

For example, after receiving the resource similar to the PUCCH SR, the base station transmits DCI including the uplink grant for PUSCH transmission.

405: the terminal equipment transmits a MAC CE indicating at least one functionality failure to the network device;

For example, the UE transmits the MAC-CE to a gNB to indicate which functionality fails.

406: the terminal equipment receives response information fed back by the network device.

It should be noted that the FIG. 4 only schematically illustrates embodiments of this disclosure, however, this disclosure is not limited thereto. For example, an order of execution of the operations may be appropriately adjusted, and some other operations may be added, or some operations therein may be removed. And appropriate variants may be made by those skilled in the art according to the above content, without being limited to the disclosure illustrated in the FIG. 4.

For another example, a functionality failure indication may be transmitted via a MAC CE. The MAC CE may be newly defined. A new MAC CE may be introduced for a plurality of functionalities, and the MAC CE may indicate at least which functionality fails; or an existing MAC CE may be reused to transmit a functionality failure indication.

For another example, the functionality failure indication may be transmitted via a two-step RACH. For example, the UE may transmit a preamble and a PUSCH to the base station, the functionality failure information is included in the PUSCH, and the UE receives an RA response transmitted by the base station.

For another example, the functionality failure indication may be transmitted via an RRC message. As for the plurality of functionalities, a separate RRC message may be defined, and the RRC message may indicate at least which functionality fails.

In embodiments of this disclosure, different functionalities may use a same manner or different manners to indicate a functionality failure. For example, as for some functionalities, a resource similar to the PUCCH SR may be used to transmit the functionality failure indication; as for other functionalities, a MAC CE may be used to transmit the functionality failure indication; as for still other functionalities, an RRC message may be used to transmit the functionality failure indication, etc.

In some embodiments, the response information is for the plurality of functionalities and is transmitted via at least one of: downlink control information (DCI), a MAC CE, or an RRC message.

For example, after receiving the functionality failure indication from the UE, the base station may transmit a response for activation/deactivation/fallback of one or more functionalities or a response for functionality switching/reconfiguration to the UE. The response may be transmitted via DCI/MAC CE/RRC message.

The above embodiments only illustrate the disclosure. However, this disclosure is not limited thereto, and appropriate variants may be made on the basis of the above embodiments. For example, the above embodiments may be used alone, or one or more of the above embodiments may be combined together.

As can be seen from the above embodiments, embodiments of this disclosure are able to accurately monitor an AI/ML model located at a terminal equipment side, thereby accuracy and reliability of the AI/ML is able to be improved.

### Embodiments of a second aspect

Embodiments of this disclosure provide a performance monitoring method described from a network device side. The embodiments of the second aspect may be combined with the embodiments of the first aspect, or may be implemented separately. Same contents as those of the embodiments of the first aspect will not be described again.

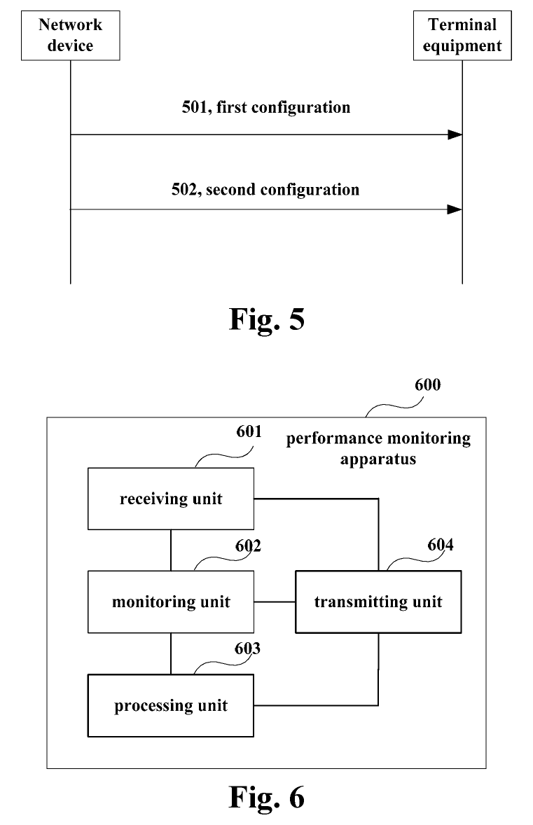

FIG. 5 is a schematic diagram illustrating a performance monitoring method in embodiments of this disclosure. As illustrated in the FIG. 5, the method includes:

501: a network device transmits a first configuration to a terminal equipment;

wherein the terminal equipment monitors a performance of an AI/ML model with an enabled or activated functionality according to the first configuration, and the functionality includes a feature or a feature group enabled by a configuration indicated by terminal equipment capability; and determines whether or not the functionality fails according to the monitoring.

In some embodiments, as illustrated in the FIG. 5, the method may further include:

502: the network device transmits a second configuration to the terminal equipment; and receives AI/ML performance information corresponding to the functionality transmitted by the terminal equipment according to the second configuration.

It should be noted that the FIG. 5 only schematically illustrates embodiments of this disclosure, however, this disclosure is not limited thereto. For example, an order of execution of the operations may be appropriately adjusted, and furthermore, some other operations may be added, or some operations therein may be removed. And appropriate variants may be made by those skilled in the art according to the above content, without being limited to the disclosure illustrated in the FIG. 5.

The above embodiments only schematically illustrate the disclosure. However, this disclosure is not limited thereto, and appropriate variants may be made on the basis of the above embodiments. For example, the above embodiments may be implemented separately, or one or more of the above embodiments may be combined together.

As can be seen from the above embodiments, embodiments of this disclosure are able to accurately monitor an AI/ML model located at a terminal equipment side, thereby accuracy and reliability of the AI/ML is able to be improved.

### Embodiments of a third aspect

Embodiments of this disclosure provide a performance monitoring apparatus, which may be, for example, a terminal equipment, or may be one or more components or assemblies configured in the terminal equipment. Same contents as those of the embodiments of the first to third aspects will not be described again.

FIG. 6 is a schematic diagram illustrating a performance monitoring apparatus in embodiments of this disclosure. As illustrated in the FIG. 6, a performance monitoring apparatus 600 includes:

a receiving unit 601 configured to receive a first configuration transmitted by a network device;

a monitoring unit 602 configured to monitor a performance of an AI/ML model with an enabled or activated functionality according to the first configuration, the functionality including a feature or a feature group enabled by a configuration indicated by terminal equipment capability; and

a processing unit 603 configured to determine whether or not the functionality fails according to the monitoring.

In some embodiments, the AI/ML model is located at the terminal equipment side.

In some embodiments, the first configuration includes at least one of a performance metric, a parameter controlling monitoring, or a reference signal configuration.

In some embodiments, the receiving unit 601 is further configured to receive a second configuration transmitted by the network device.

In some embodiments, as illustrated in the FIG. 6, the performance monitoring apparatus 600 may further include:

a transmitting unit 604 configured to transmit AI/ML performance information corresponding to the functionality to the network device according to the second configuration.

In some embodiments, the second configuration includes at least one of: a reporting configuration, an uplink resource for transmitting the AI/ML performance information, and a manner for reporting the AI/ML performance information. The manner includes: a periodic reporting, a semi-persistent reporting, or an aperiodic reporting. The AI/ML performance information includes at least one of: a functionality failure indication, an input data drift, or an output data drift.

In some embodiments, the functionality is one or more, and the terminal equipment performs AI/ML performance monitoring on functionalities, respectively.

In some embodiments, the receiving unit 601 receives a reference signal for AI/ML performance monitoring transmitted by the network device; and the processing unit 603 determines whether or not the functionality fails according to the reference signal.

In some embodiments, in a case where the functionality fails, the transmitting unit 604 transmits indication information to the network device; and the receiving unit 601 also receives response information fed back by the network device according to the indication information, and the response information includes at least one of: functionality activation information, functionality deactivation information, functionality fallback information, functionality switching information or reconfiguration information.

In some embodiments, the processing unit 603 determines whether or not the functionality fails based on a performance metric; wherein in a case where the performance metric falls below a threshold, one or more failure instances are counted; and in a case where a plurality of consecutive failure instances are detected within a time window, the functionality is determined to fail.

In some embodiments, the reference signal is a periodic signal for AI/ML performance monitoring on one functionality.

In some embodiments, the reference signal for AI/ML performance monitoring on one functionality is configured by radio resource control (RRC), or the reference signal for AI/ML performance monitoring on one functionality is determined by the terminal equipment.

In some embodiments, the indication information includes a failure indication of one functionality.

In some embodiments, the failure indication of the one functionality is transmitted via at least one of a dedicated random access channel resource, an uplink control channel resource, a MAC CE, a two-step random access, or a radio resource control (RRC) message.

In some embodiments, the response information is for the one functionality and is transmitted via at least one of: downlink control information (DCI), a MAC CE, or an RRC message.

In some embodiments, the reference signal is a periodic signal for AI/ML performance monitoring on a plurality of functionalities.

In some embodiments, the reference signal for AI/ML performance monitoring on a plurality of functionalities is configured by radio resource control (RRC), or the reference signal for AI/ML performance monitoring on a plurality of functionalities is determined by the terminal equipment.

In some embodiments, the indication information includes a failure indication of one or more functionalities.

In some embodiments, the failure indication of the one or more functionalities is transmitted via at least one of: an uplink control channel resource, a MAC CE, a two-step random access, or a radio resource control (RRC) message.

In some embodiments, the response information is for the one or more functionalities and is transmitted via at least one of: downlink control information (DCI), a MAC CE, or an RRC message.

The above embodiments only schematically illustrate the disclosure. However, this disclosure is not limited thereto, and appropriate variants may be made on the basis of the above embodiments. For example, the above embodiments may be implemented separately, or one or more of the above embodiments may be combined together.

It should be noted that the components or modules related to this disclosure are only described above, however, this disclosure is not limited thereto. The performance monitoring apparatus 600 may also include other components or modules. Refer to the related arts for the specific content of these components or modules.

In addition, for the sake of simplicity, the FIG. 6 only illustrates a connection relationship or a signaling direction between components or modules, however, those skilled in the art should appreciate that the related arts such as bus connections can be adopted. The components or modules can be implemented by hardware facilities, such as a processor, a memory, a transmitter, and a receiver, which is not limited in this disclosure.

As can be seen from the above embodiments, embodiments of this disclosure are able to accurately monitor an AI/ML model located at a terminal equipment side, thereby accuracy and reliability of the AI/ML is able to be improved.

### Embodiments of a fourth aspect

Embodiments of this disclosure provide a performance monitoring apparatus, which may be, for example, a network device, or may be one or more components or assemblies configured in the network device. Same contents as those of the embodiments of the first to third aspects will not be described again.

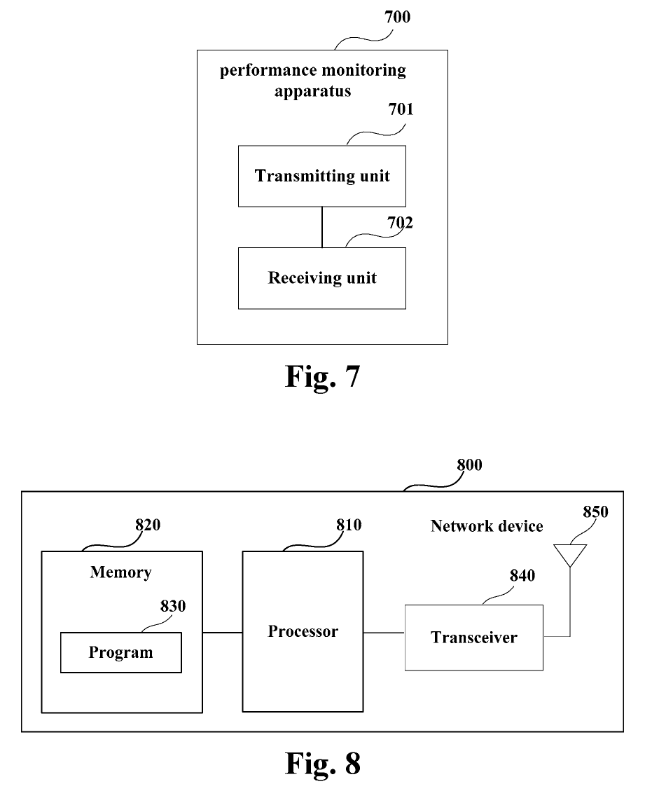

FIG. 7 is a schematic diagram illustrating a performance monitoring apparatus in embodiments of this disclosure. As illustrated in the FIG. 7, a performance monitoring apparatus 700 includes:

a transmitting unit 701 configured to transmit a first configuration to a terminal equipment;

wherein the terminal equipment monitors a performance of an AI/ML model with an enabled or activated functionality according to the first configuration, and the functionality includes a feature or a feature group enabled by a configuration indicated by terminal equipment capability; and determines whether or not the functionality fails according to the monitoring.

In some embodiments, as illustrated in the FIG. 7, the performance monitoring apparatus 700 may further include:

a receiving unit 702 configured to receive indication information transmitted by the terminal equipment in a case where the functionality fails.

In some embodiments, the transmitting unit 702 further transmits response information according to the indication information, and the response information includes at least one of: functionality activation information, functionality deactivation information, functionality fallback information, functionality switching information or reconfiguration information.

The above embodiments only schematically illustrate the disclosure. However, this disclosure is not limited thereto, and appropriate variants may be made on the basis of the above embodiments. For example, the above embodiments may be implemented separately, or one or more of the above embodiments may be combined together.

It should be noted that the components or modules related to this disclosure are only described above, however, this disclosure is not limited thereto. The performance monitoring apparatus 700 may also include other components or modules. Refer to the related arts for the specific content of these components or modules.

In addition, for the sake of simplicity, the FIG. 7 only illustrates a connection relationship or a signaling direction between components or modules, however, those skilled in the art should appreciate that the related arts such as bus connections can be adopted. The components or modules can be implemented by hardware facilities, such as a processor, a memory, a transmitter, and a receiver, which is not limited in this disclosure.

As can be seen from the above embodiments, embodiments of this disclosure are able to accurately monitor an AI/ML model located at a terminal equipment side, thereby accuracy and reliability of the AI/ML is able to be improved.

### Embodiments of a fifth aspect

Embodiments of this disclosure also provide a communication system, and reference may be made to the FIG. 1. Same contents as those of the embodiments of the first to fourth aspects will not be described again.

In some embodiments, the communication system 100 may at least include:

a network device configured to transmit a first configuration to a terminal equipment; and

the terminal equipment configured to monitor a performance of an AI/ML model with an enabled or activated functionality according to the first configuration, wherein the functionality includes a feature or a feature group enabled by a configuration indicated by terminal equipment capability; and determine whether or not the functionality fails according to the monitoring.

Embodiments of this disclosure further provide a network device, which may be, for example, a base station, however, this disclosure is not limited thereto and other network devices may also be involved.

FIG. 8 is a schematic diagram illustrating a network device in embodiments of this disclosure. As illustrated in the FIG. 8, a network device 800 may include: a processor 810 (such as a central processing unit CPU) and a memory 820. The memory 820 is coupled to the processor 810. The memory 820 may store various data. In addition, the memory 820 may store a program 830 for information processing, and the program 830 may be executed under the control of the processor 810.

For example, the processor 810 may be configured to execute a program to implement the performance monitoring method according to the embodiments of the second aspect. For example, the processor 810 may be configured to transmit a first configuration to a terminal equipment, wherein the terminal equipment monitors a performance of an AI/ML model with an enabled or activated functionality according to the first configuration, the functionality includes a feature or a feature group enabled by a configuration indicated by terminal equipment capability; and determines whether or not the functionality fails according to the monitoring.

In addition, as illustrated in the FIG. 8, the network device 800 may further include: a transceiver 840 and an antenna 850, wherein the functions of the components are similar to those of the relevant art and are not described in detail herein. It should be noted that the network device 800 does not necessarily include all the components illustrated in the FIG. 8. In addition, the network device 800 may also include components not illustrated in the FIG. 8. Please refer to the relevant art.

Embodiments of this disclosure also provide a terminal equipment, however, this disclosure is not limited thereto, and other devices may also be involved.

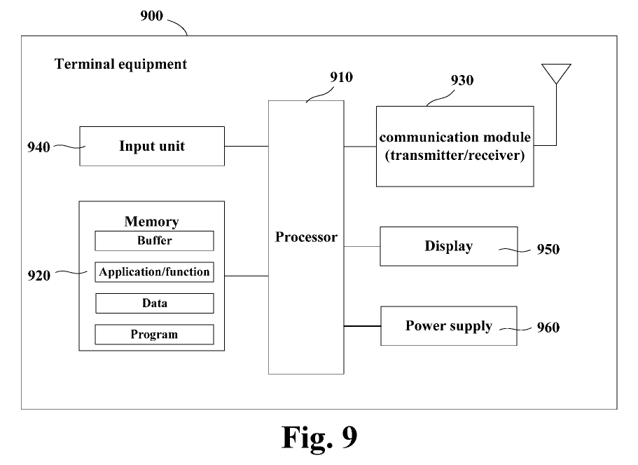

FIG. 9 is a schematic diagram illustrating a terminal equipment in embodiments of this disclosure. As illustrated in the FIG. 9, a terminal equipment 900 may include a processor 910 and a memory 920 that stores data and a program and is coupled to the processor 910. It should be noted that this figure is exemplary; and other types of structures may also be used to supplement or replace this structure, in order to implement telecommunication functions or other functions.

For example, the processor 910 may be configured to execute a program to implement the performance monitoring method according to the embodiments of the first aspect. For example, the processor 910 may be configured to receive a first configuration transmitted by a network device; monitor a performance of an AI/ML model with an enabled or activated functionality according to the first configuration, wherein the functionality includes a feature or a feature group enabled by a configuration indicated by terminal equipment capability; and determine whether the functionality or not fails according to the monitoring.

As illustrated in the FIG. 9, the terminal equipment 900 may further include: a communication module 930, an input unit 940, a display 950, and a power supply 960. The functions of the above components are similar to those in the relevant art and will not be described in detail herein. It should be noted that the terminal equipment 900 does not necessarily include all the components illustrated in the FIG. 9, and the above components are not necessarily required. In addition, the terminal equipment 900 may also include components not illustrated in the FIG. 9. Please refer to the relevant art.

Embodiments of this disclosure also provide a computer program, wherein when the program is executed in a terminal equipment, the program enables the terminal equipment to execute the performance monitoring method according to the embodiments of the first aspect.

Embodiments of this disclosure also provide a storage medium storing a computer program, wherein the computer program enables a terminal equipment to perform the performance monitoring method according to the embodiments of the first aspect.

Embodiments of this disclosure also provide a computer program, wherein when the program is executed in a network device, the program enables the network device to perform the performance monitoring method according to the embodiments of the second aspect.

Embodiments of this disclosure further provide a storage medium storing a computer program, wherein the computer program enables a network device to perform the performance monitoring method according to the embodiments of the second aspect.

The above device and method of this disclosure can be implemented by hardware, or by hardware in combination with software. This disclosure relates to such a computer-readable program that when the program is executed by a logic device, the logic device is enabled to carry out the device or components as described above, or to carry out the method or steps as described above. This disclosure also relates to a storage medium for storing the above program, such as a hard disk, a magnetic disk, a CD, a DVD, a flash memory, etc.

The method/device described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And these hardware modules, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this disclosure. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations containing the above embodiments, supplements are further disclosed below:

1. A performance monitoring method, including:

receiving, by a terminal equipment, a first configuration transmitted by a network device;

monitoring a performance of an AI/ML model with an enabled or activated functionality according to the first configuration, the functionality including a feature or a feature group enabled by a configuration indicated by terminal equipment capability; and

determining whether or not the functionality fails according to the monitoring.

2. A performance monitoring method, including:

transmitting, by a network device, a first configuration to a terminal equipment;

wherein the terminal equipment monitors a performance of an AI/ML model with an enabled or activated functionality according to the first configuration, and the functionality includes a feature or a feature group enabled by a configuration indicated by terminal equipment capability; and determines whether or not the functionality fails according to the monitoring.

3. A terminal equipment, including: a memory and a processor, wherein the memory stores a computer program, and the processor is configured to execute the computer program to implement the performance monitoring method as claimed in supplement 1.

4. A network device, including: a memory and a processor, wherein the memory stores a computer program, and the processor is configured to execute the computer program to implement the performance monitoring method as claimed in supplement 2.

1. A performance monitoring apparatus, comprising:
a receiver configured to receive a first configuration transmitted by a network device;
a monitor configured to monitor a performance of an AI/ML (Artificial Intelligence/Machine Learning) model with an enabled or activated functionality according to the first configuration, the functionality comprising a feature or a feature group enabled by a configuration indicated by terminal equipment capability; and
processor circuitry configured to determine whether or not the functionality fails according to monitoring.

2. The apparatus according to claim 1, wherein the AI/ML model is located at a terminal equipment side, and the first configuration comprises at least one of the following: a performance metric, a parameter for controlling monitoring, or a reference signal configuration.

3. The apparatus according to claim 1, the apparatus further comprising:
a transmitter configured to transmit AI/ML performance information corresponding to the functionality to the network device according to the second configuration,
wherein the receiver is further configured to receive a second configuration transmitted by the network device.

4. The apparatus according to claim 3, wherein the second configuration comprises at least one of the following: a reporting configuration, an uplink resource for transmitting AI/ML performance information, or a manner of reporting AI/ML performance information; the manner comprises: a periodic reporting, a semi-persistent reporting, or an aperiodic reporting; the AI/ML performance information comprises at least one of the following: a functionality failure indication, an input data drift, or an output data drift.

5. The apparatus according to claim 1, wherein the functionality is one or more, and the terminal equipment performs an AI/ML performance monitoring on each functionality, respectively.

6. The apparatus according to claim 1, wherein the receiver is configured to receive a reference signal for AI/ML performance monitoring transmitted by the network device; and
the processor circuitry is configured to determine whether or not the functionality fails according to the reference signal.

7. The apparatus according to claim 6, the apparatus further comprising:
a transmitter configured to transmit indication information to the network device in a case where the functionality fails,
wherein the receiver is further configured to receive response information fed back by the network device according to the indication information, the response information comprising at least one of the following: functionality activation information, functionality deactivation information, functionality fallback information, functionality switching information or reconfiguration information.

8. The apparatus according to claim 1, wherein the processor circuitry is configured to determine whether or not the functionality fails according to a performance metric; and
wherein in a case where the performance metric is below a threshold, one or more failure instances are counted; and in a case where a plurality of consecutive failure instances are detected within a time window, the functionality is determined to fail.

9. The apparatus according to claim 6, wherein the reference signal is a periodic signal for AI/ML performance monitoring on one functionality.

10. The apparatus according to claim 9, wherein the reference signal for AI/ML performance monitoring on one functionality is configured by radio resource control, or the reference signal for AI/ML performance monitoring on one functionality is determined by the terminal equipment.

11. The apparatus according to claim 7, wherein the indication information comprises a failure indication of one functionality.

12. The apparatus according to claim 11, wherein the failure indication of the one functionality is transmitted via at least one of the following: a dedicated random access channel resource, an uplink control channel resource, a MAC (media access control) CE (control element), a two-step random access, or a radio resource control message.

13. The apparatus according to claim 11, wherein the response information is for the one functionality and is transmitted via at least one of the following: downlink control information, a MAC CE, or a radio resource control message.

14. The apparatus according to claim 6, wherein the reference signal is a periodic signal for AI/ML performance monitoring on a plurality of functionalities.

15. The apparatus according to claim 14, wherein the reference signal for AI/ML performance monitoring on a plurality of functionalities is configured by radio resource control, or the reference signal for AI/ML performance monitoring on a plurality of functionalities is determined by the terminal equipment.

16. The apparatus according to claim 7, wherein the indication information comprises a failure indication of one or more functionalities.

17. The apparatus according to claim 16, wherein the failure indication of the one or more functionalities is transmitted via at least one of the following: an uplink control channel resource, a MAC CE, a two-step random access, or a radio resource control message.

18. The apparatus according to claim 16, wherein the response information is for the one or more functionalities and is transmitted via at least one of the following: downlink control information, a MAC CE, or a radio resource control message.

19. A performance monitoring apparatus, comprising:
a transmitter configured to transmit a first configuration to a terminal equipment;
wherein the terminal equipment monitors a performance of an AI/ML model with an enabled or activated functionality according to the first configuration, the functionality comprising a feature or a feature group enabled by a configuration indicated by terminal equipment capability; and determines whether or not the functionality fails according to monitoring.

20. A communication system, comprising:
a network device configured to transmit a first configuration to a terminal equipment; and
the terminal equipment configured to monitor a performance of an AI/ML model with an enabled or activated functionality according to the first configuration, wherein the functionality comprises a feature or a feature group enabled by a configuration indicated by terminal equipment capability; and determine whether or not the functionality fails according to monitoring.
